(19) United States
(12) Patent Application Publication
(10) Pub. No.: US 2012/0057717 A1
(43) Pub. Date: Mar. 8, 2012

(54) Noise Suppression for Sending Voice with Binaural Microphones

(75) Inventor: Martin Nyström, Horja (SE)

(73) Assignee: Sony Ericsson Mobile Communications AB, Lund (SE)

(21) Appl. No.: 12/874,463

(22) Filed: Sep. 2, 2010

(51) Int. Cl. G10K 11/16

(52) U.S. Cl. 381/71.6

(57) ABSTRACT

Noise-suppressing techniques using a dual-microphone headset include methods in which first and second audio input signals are generated from first and second microphones placed in or near a user's ears, or on each side of the user's throat. These audio input signals are correlated, to produce a correlation signal, and are also combined, to produce an intermediate audio signal. An output audio signal is generated by selectively adjusting the amplitude of the intermediate audio signal, based on the correlation signal, to emphasize correlated components of the first and second audio input signals, relative to uncorrelated components.

### BACKGROUND

The present invention relates generally to sound systems for mobile devices and, more particularly to techniques for suppressing background noise in portable audio devices using dual-microphone headsets.

Mobile devices, such as mobile phones, are increasingly used with so-called hands-free technology, for reasons of both safety and convenience. This hands-free technology frequently includes audio headsets of various configurations, including both wired and wireless headsets.

Dual-microphone technology is now being applied to mobile handsets, to facilitate sophisticated noise suppression techniques. In a typical configuration, one microphone is positioned close to the user's mouth, to capture the voice, while another is positioned elsewhere, such as on the back of the handset, to capture background noise. An audio processing circuit, generally based on a specialized digital signal processor (DSP) effectively subtracts the background noise from the signal containing the user's voice, to produce a reduced-noise signal.

An audio headset for telephony applications typically includes two earpieces, which generally produce monaural sound in the context of a phone call but may produce stereophonic sound for other applications, such as music playback. These audio headsets conventionally include only a single microphone, for capturing the user's voice during a phone call. However, interest in dual-microphone headsets for mobile telephony applications is growing.

### SUMMARY

Noise-suppressing techniques using a dual-microphone headset are disclosed. In an example noise-suppression process, first and second audio input signals are generated from first and second microphones placed in or near a user's ears, or, in some embodiments, on each side of the user's throat. These audio input signals are correlated, to produce a correlation signal, and are also combined, to produce an intermediate audio signal. An output audio signal is generated by selectively adjusting the amplitude of the intermediate audio signal, based on the correlation signal, to emphasize correlated components of the first and second audio input signals, relative to uncorrelated components.

In some embodiments, the first and second audio input signals and the correlation signal are analog signals, and the correlation signal is used to control an analog variable-gain amplifier circuit to generate the output audio signal. In other embodiments, the first and second audio input signals are digital signals generated by sampling first and second analog signals collected at the first and second microphone inputs. Correlations of one or several types may be used, including time-domain cross-correlation, frequency-domain cross-correlation, and/or amplitude cross-correlation.

Noise-suppressing apparatus corresponding generally to the disclosed noise-suppressing processes are also disclosed. These systems include a dual-microphone headset configured to provide first and second audio input signals from first and second microphones configured for placement in or near a user's ears, and an audio processing circuit. The audio processing circuit in turn comprises a correlator circuit configured to correlate the first and second audio input signals to produce a correlation signal, a combiner circuit configured to combine the first and second audio input signals, to produce an intermediate audio signal, and a gain circuit. The gain circuit is configured to generate an output audio signal by selectively adjusting the amplitude of the intermediate audio signal, based on the correlation signal, to emphasize correlated components of the first and second audio input signals, relative to uncorrelated components.

Further refinements of the methods and apparatus summarized above are also disclosed. Of course, those skilled in the art will appreciate that the present invention is not limited to the above features, advantages, contexts, or examples, and will recognize additional features and advantages upon reading the following detailed description and upon viewing the accompanying drawings.

### BRIEF DESCRIPTION OF THE DRAWINGS

FIG. 1 illustrates a cellular handset and dual-microphone headset according to some embodiments of the present invention.

FIG. 2 is a process flow diagram illustrating an example technique for suppressing noise using a dual-microphone headset.

FIG. 3 schematically illustrates an audio-processing circuit.

FIG. 4 illustrates functional details of an example correlator circuit.

### DETAILED DESCRIPTION

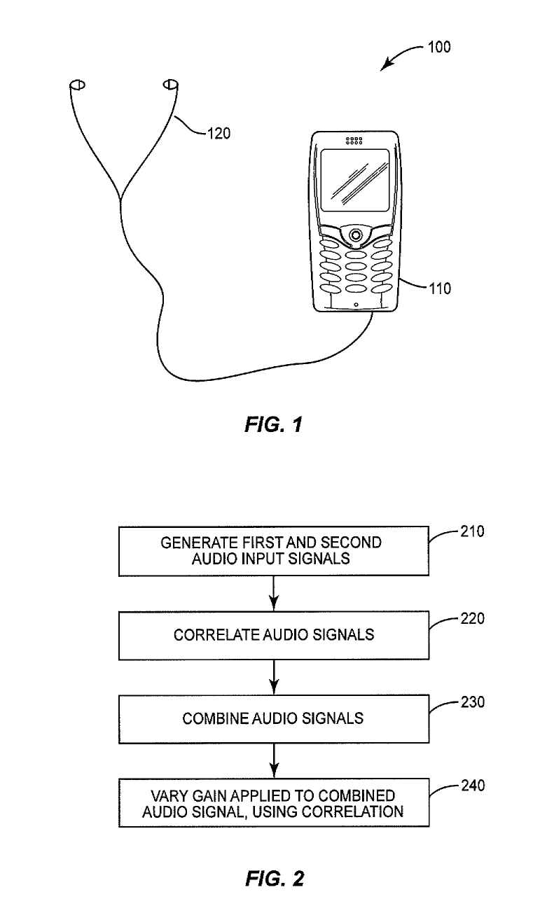

Referring now to the drawings, a noise-suppression system according to one exemplary embodiment of the present invention is shown therein and indicated generally by the numeral 100. In FIG. 1, the illustrated embodiment comprises a mobile phone 110 with a wired headset 120 connected thereto. Those skilled in the art will appreciate that other embodiments of the system pictured in FIG. 1 may involve other user devices with communication capabilities, such as a computing tablet, laptop computer, audio player, or other mobile device. Likewise, while system 100 includes a handset coupled to a wired headset 120, the inventive techniques disclosed herein are equally applicable to wireless headset devices, such as those that communicate with a nearby handset using Bluetooth® short-range wireless technology.

As briefly discussed above, some dual-microphone systems implemented on wireless handsets use one microphone that is positioned close to the expected position of the user's mouth, with a second, “remote,” microphone positioned away from the user's mouth. The noise-suppression techniques used in these systems operate on the premise that the audio signals from these two microphones will have similar levels of background noise, but drastically different levels of the desired voice signal. To the extent that this is true, subtracting the signal obtained from the remote microphone from the signal obtained by the voice-collecting microphone should suppress all or part of the background noise. Thus, the basic principle behind these systems is that the components of the microphone signals that are most highly correlated, i.e., the background noise, are suppressed. Various feedback techniques, filtering processes, and the like may be employed to further improve the operation of such noise-suppression systems.

Systems according to the present invention, on the other hand, are based on a different premise. If a microphone is placed in, at, or near each of the user's ears, the acoustic channel traveled by the user's voice to each microphone (whether through the air, through the user's skull and jaw, or both) will be very similar. The same is true if two so-called throat microphones, which pick up sound through sensors in direct contact with the neck, are placed in symmetric (or close to symmetric) locations on each side of the user's neck. In either case, the two microphone signals will each have a very similar, i.e., highly-correlated, voice component. On the other hand, at least some elements of background noise picked up by the two microphones will be uncorrelated. This is particularly true for microphones positioned in the user's ear or very close to the head, as the user's head will block the path between certain noise sources and one microphone, but not the other. Combining the two microphone signals in a manner that emphasizes correlated components of the signals, relative to the uncorrelated components, will suppress these noise components.

FIG. 2 is a process flow diagram illustrating an example approach to noise-suppression according to these principles. As shown at block 210, first and second audio input signals are generated, at first and second microphones in a dual-microphone headset. As noted above, the headset may be wireless or wired. These microphone signals are then correlated, as shown at block 220, to produce a correlation signal. (As used herein, the term “correlation,” is generally intended to refer to a measure of the similarity between two signals. Thus, unless otherwise indicated, the term “correlation” is synonymous with “cross-correlation.”) The two microphone signals are also combined, as indicated at block 230, to form an intermediate combined audio signal. The amplitude of the combined audio signal is then selectively varied, based on the result of the correlation, as shown at block 240. This varying of the amplitude, which may be performed using a variable-gain amplifier, for example, emphasizes correlated components of the first and second audio input signals, relative to uncorrelated components.

In particular, when the two signals are highly correlated, the gain applied to the combined signal is increased. Conversely, when the correlation between the two signals is low, the gain applied to the combined signal is decreased. Any of a wide variety of transfer functions between the correlation output and the applied gain may be used. The most appropriate transfer function will depend at least partly on the microphone characteristics and the precise physical configuration of the headset—an appropriate transfer function may be determined experimentally by testing a range of transfer functions against the specific hardware. In some cases, multiple transfer functions may be preprogrammed into a user device; these transfer functions may be mapped to particular headset configurations, in some embodiments. In others, the user may be permitted to select a preferred noise-suppression transfer function; in still others, the audio processing circuit may be configured to analyze the background noise, using sampled data from one or both microphone inputs, and to dynamically select or adapt a transfer function based on one or more characteristics of the background noise.

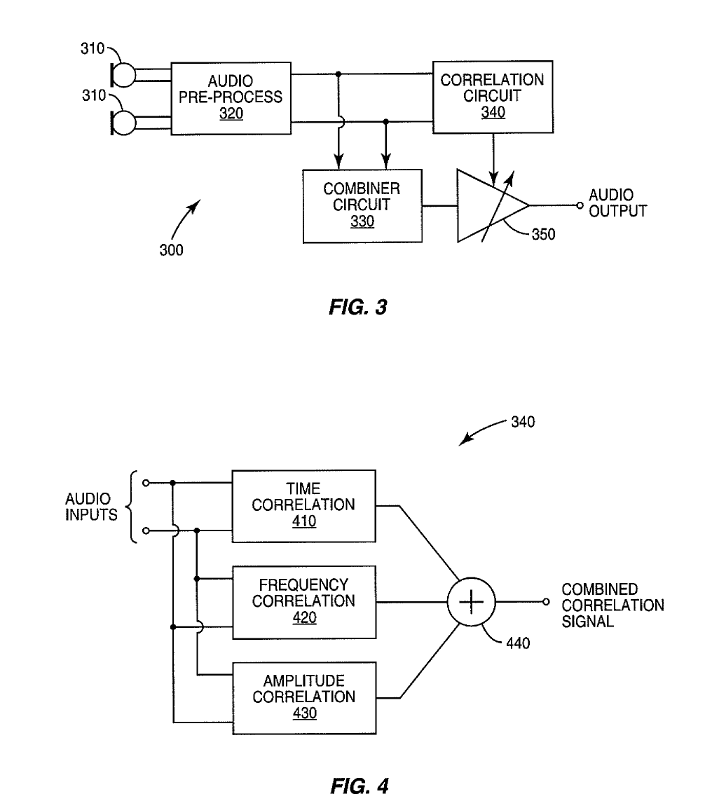

FIG. 3 is a block diagram of a noise-suppressing system configured to suppress noise according to the technique illustrated in FIG. 2. FIG. 3 thus illustrates a pair of microphones 310, coupled to an audio processing circuit 300. Audio processing circuit 300 includes an audio pre-processing circuit 320, which includes, in some embodiments, amplification and filtering. In some embodiments, as will be discussed in further detail below, audio pre-processing circuit 320 further includes an analog-to-digital converter (ADC) coupled to each of the analog signals from microphones 310.

The audio signals from audio pre-processing circuit 320 (whether in analog or digital form) are provided to combiner circuit 330 and correlator 340. Combiner circuit 330 combines the two signals to form an intermediate audio signal that is fed to variable-gain amplifier 350. Correlator circuit 340 performs a correlation between the two signals to generate a correlation signal—the correlation signal is used to vary the gain of variable-gain amplifier 350, resulting in the emphasis of correlated components of the two microphone signals, relative to uncorrelated components.

The signal processing in the process illustrated in FIG. 2, and in the combiner 330, correlator 340, and variable-gain circuit 350 of FIG. 3, may be in the analog domain, the digital domain, or some combination of both. For example, the signals from each microphone may be digitized, using conventional digital sampling techniques, close to the “front end” of the system, i.e., shortly after the acoustic energy collected by the microphone is converted into an electrical signal. Analog conditioning of the signal prior to digitization may include only amplification and basic filtering, in some cases. In these systems, the subsequent processing of the signals, i.e., the correlation, combining, and variable gain amplification, is performed in the digital domain, using a digital signal processor. As will be discussed in further detail below, the digital approach allows for the greatest flexibility in choosing the type or types of correlation that will be performed.

In other embodiments, the correlation of the two microphone signals may be performed in the analog domain. In this case, correlator circuit 340 may comprise, for example, an audio mixer circuit and a low-pass filter. The low-pass filter in this embodiment establishes a time constant for the correlation process—two signals that have similar amplitudes for a period of time on the order of this time constant will yield a high correlation value, while binaural signals that do not track one another in amplitude will produce lower correlation values.

Similarly, the two microphone signals can be combined using an analog summing circuit, in which case combiner circuit 330 may comprise, for example, a summing amplifier. In these embodiments, the analog correlation signal from the correlator may be used to drive an analog variable-gain amplifier operating on the combined signal from the summing circuit, thus emphasizing correlated components of the microphone signals that appear in the combined signal.

In some embodiments, most of the audio processing in audio processing circuit 300 is performed in the digital domain, using one or more suitably programmed microprocessors, special-purpose digital signal processors, as well as, in some cases, specially designed digital logic. In these digital systems, then, audio processing circuit 300 is implemented in part with at least one processor and associated memory, the memory containing program instructions in the form of software and/or firmware, for execution by the at least one processor. Thus, for example, the amplitude correlation and filtering process described above can be readily implemented using well-known digital signal processing techniques.

One advantage to a digital implementation of the system of FIG. 3 is that the correlation between the two audio input signals can be performed in one or more of several different domains. Amplitude correlation between the two signals is readily calculated from digital samples of the two microphone signals. By delaying one of the signals relative to the other before (e.g., by shifting one signal by one or more samples), various correlations in the time-domain can be performed. In this manner, for example, signals that are highly correlated in time, i.e., with very small delay differences, can be emphasized relative to signals that appear in both microphone signals but with larger differences in arrival time. Because the propagation paths for the user's voice to the binaural microphone inputs are symmetric, or very nearly so, voice signals from the headset user will be highly time-correlated, and will be emphasized relative to background noise.

If the digitized sample stream is converted into frequency domain samples using, for example, a fast-Fourier transform (FFT) algorithm, then correlator circuit 340 can perform a frequency-domain correlation between the two signals. Furthermore, the results of two or more different types of correlation may be combined, in some embodiments. Thus, for example, frequency components having very similar amplitude profiles in the binaural microphone inputs can be emphasized, relative to frequency components that exhibit significantly different amplitudes in the two inputs. An even more general example of this is shown in FIG. 4, where correlator 340 performs three correlation functions, time correlation 410, frequency correlation 420, and amplitude correlation 430, and sums the results in summer 440. The combined correlation signal (which may be an unequally weighted sum of the multiple correlation results, in some embodiments) is then used to selectively adjust the amplitude of the audio signal formed by combining the two microphone signals, thus emphasizing correlated components of the first and second audio input signals.

The present invention may, of course, be carried out in other specific ways than those herein set forth without departing from the scope and essential characteristics of the invention. Those skilled in the art will further appreciate that the techniques presented herein for suppressing noise in binaural microphone inputs may be combined with other noise suppression techniques, for improved noise suppression performance and/or for suppression of particular types or sources of noise. The present embodiments are, therefore, to be considered in all respects as illustrative and not restrictive, and all changes coming within the meaning and equivalency range of the appended claims are intended to be embraced therein.

What is claimed is:

1. A method for suppressing noise using a dual-microphone headset, the method comprising:
generating first and second audio input signals from first and second microphones placed in or near a user's ears, or placed on each side of the user's throat;
correlating the first and second audio input signals to produce a correlation signal;
combining the first and second audio input signals, to produce an intermediate audio signal;
generating an output audio signal by selectively adjusting the amplitude of the intermediate audio signal, based on the correlation signal, to emphasize correlated components of the first and second audio input signals, relative to uncorrelated components.

2. The method of claim 1, wherein the first and second audio input signals and the correlation signal are analog signals, and the correlation signal is used to control an analog variable-gain amplifier circuit to generate the output audio signal.

3. The method of claim 1, wherein the first and second audio input signals are digital signals generated by sampling first and second analog signals collected at the first and second microphone inputs.

4. The method of claim 1, wherein correlating the first and second audio input signals comprises a time-domain cross-correlation.

5. The method of claim 1, wherein correlating the first and second audio input signals comprises a frequency-domain cross-correlation.

6. The method of claim 1, wherein correlating the first and second audio input signals comprises an amplitude cross-correlation.

7. The method of claim 1, wherein correlating the first and second audio input signals comprises at least two of:
a frequency-domain correlation;
a time-domain cross-correlation; and
an amplitude correlation.

8. A noise-suppression system, comprising:
a dual-microphone headset configured to provide first and second audio input signals from first and second microphones configured for placement in or near a user's ears, or on each side of the user's throat; and
an audio processing circuit comprising:
a correlator circuit configured to correlate the first and second audio input signals to produce a correlation signal;
a combiner circuit configured to combine the first and second audio input signals, to produce an intermediate audio signal; and
a gain circuit configured to generate an output audio signal by selectively adjusting the amplitude of the intermediate audio signal, based on the correlation signal, to emphasize correlated components of the first and second audio input signals, relative to uncorrelated components.

9. The noise-suppression system of claim 8, wherein the first and second audio input signals and the correlation signal are analog signals, and wherein the gain circuit includes an analog variable-gain amplifier circuit controlled by the correlation signal.

10. The noise-suppression system of claim 8, wherein the audio processing circuit further comprises a sampling circuit configured to digitize the first and second audio input signals, and wherein the correlator circuit is configured to correlate the digitized first and second audio input signals.

11. The noise-suppression system of claim 8, wherein the correlator circuit is configured to correlate the first and second audio input signals using a time-domain cross-correlation.

12. The noise-suppression system of claim 8, wherein the correlator circuit is configured to correlate the first and second audio input signals using a frequency-domain cross-correlation.

13. The noise-suppression system of claim 8, wherein the correlator circuit is configured to correlate the first and second audio input signals using an amplitude cross-correlation.

14. The noise-suppression system of claim 8, wherein the correlator circuit is configured to correlate the first and second audio input signals using at least two of:
a frequency-domain correlation;
a time-domain cross-correlation; and
an amplitude correlation.
